(19) United States
(12) Patent Application Publication
(10) Pub. No.: US 2018/0056513 A1
(43) Pub. Date: Mar. 1, 2018

(54) METHOD FOR CONTROLLING A MANIPULATOR FOR CARRYING OUT A WORKING PROCESS

(71) Applicant: KUKA Roboter GmbH, Augsburg (DE)

(72) Inventor: Burkhard STIMMEL, Eurasburg (DE)

(21) Appl. No.: 15/557,609

(22) PCT Filed: Mar. 11, 2016
(86) PCT No.: PCT/EP2016/055257

§ 371 Date: Sep. 12, 2017

(30) Foreign Application Priority Data
Mar. 13, 2015 (DE) 10 2015 204 599.4

(51) Int. Cl. B25J 9/16

(52) U.S. Cl. CPC B25J 9/1664; G05B 2219/45135; G05B 2219/36417; B25J 9/1679

(57) ABSTRACT

A method for controlling at least one manipulator for carrying out a working process which is controlled by a process controller comprises the steps of: a) providing one or more working points to be approached by the manipulator, b) approaching a working point Aₙ by the manipulator, c) checking whether a subsequent working point Aₙ₊₁ is present and, if a subsequent working point Aₙ₊₁ is present, d) retrieving one or more data sets for the subsequent working point Aₙ₊₁ while the working process is being carried out at the working point Aₙ.

### 1. TECHNICAL FIELD

The present invention generally refers to a method for controlling at feast one manipulator for carrying out a working process as well as to a manipulator system for carrying out such a method.

### 2. TECHNICAL BACKGROUND

Manipulators, such as robots with articulated arms, are used in various working processes, such as in mounting or manufacturing processes in an industrial environment. The at least one manipulator is controlled accordingly by a manipulator controller and the working process or process advancement is controlled by a process controller.

A known working process consists for instance of approaching a working point, which is predetermined in a path planning, by a manipulator. When the working point is reached, at least a program for the working process is activated by the process controller and correspondingly carried out by the manipulator, or by an end effector or tool provided on the manipulator.

At the beginning of a working process, process data for respective working points to be processed are usually loaded or entered by a process operator into the process controller. These process data comprise, in particular, data relevant for movement, for controlling the working process, which are provided to the manipulator controller, in order for the manipulator to exactly position itself for carrying out the working process. Moreover, the process controller or the process data comprise parameters for the respective desired working process, such as the welding power, if a welding process has to be carried out.

Internal processes are known, in which process data for a working point are transmitted from the process controller to the manipulator controller, after the manipulator has approached the respective working point. This means, that the manipulator approaches a working point, and only when it has reached it, the manipulator controller retrieves the process data from the process controller. This, however, has the drawback, that the manipulator is inactive during some of the process cycles, since the manipulator can only approach its final position for the working process, for example, after receiving the process data.

In view of above said methods, the object of the present invention consists in providing a method and a system that allows a reduction of the cycle time while carrying out a working process, thus optimizing the working process as a whole. Moreover, an improved, more synchronized positioning of the manipulator and in particular of the tool provided on the same has to be ensured.

This and further objects are achieved by the subject matter of the main claims.

### 3. SUMMARY OF THE INVENTION

The present invention comprises a method for controlling at least one manipulator for carrying out a working process, which is controlled by a process controller. In particular, a path process is preferably provided, i.e. a working process, which is not carried out by a stationary manipulator. The path process comprises one or more working points, which are approached during the execution of the working process.

The method initially comprises the step of providing one or more working points, which have to be approached by the manipulator. The working points are points of a path planning, at which the manipulator actually carries out a working process, such as in the case of a working process for point welding, around the single welding points. The working points themselves may also comprise the execution of the working process, i.e. the welding, in case of a continuous welding process. In case of a continuous welding process, the working points comprise, for example, the path, along which a working process is actually carried out, such as the path welding along a track. Alternatively, the working point may simply comprise the beginning of a processing, i.e. a path, along which a working process is actually performed. The manipulator may, in this case, subsequently travel along a path, along which it carries out the processing or working process. Working points have to be differentiated from path points, which only define the movement of the manipulator and in which no working process is performed. Such path points are auxiliary points in space, for example, which have to avoid that the manipulator collides with obstacles.

In a further step, a working point Aₙ is approached by the manipulator. This is not necessarily a first working point of the path planning, but any desired working point, which is provided along the path planning, i.e. which is provided by the process controller for executing the working process. The approaching comprises, in this case, both the movement of the manipulator towards the working point and the actual reaching of the working point by the tool or manipulator.

In a further step it is checked, whether a subsequent working point Aₙ₊₁ is present. This is preferably clone according to the path planning, In a further step, if a subsequent working point Aₙ₊₁ is present, one or more data sets for the subsequent working point Aₙ₊₁ are retrieved, in particular while the working process is carried out at the working point Aₙ. In this way, downtimes of manipulator are advantageously reduced. Since the required data sets for the subsequent working point Aₙ₊₁ are provided at an early stage, in particular before the manipulator has started approaching the subsequent working point, the provided data sets may be used in the manipulator controller also for optimizing the path planning for approaching the subsequent working point.

Preferably, the one or more data sets for subsequent working point Aₙ₊₁ are retrieved by the manipulator controller. Particularly preferred is the case, in which the one or more datasets for subsequent working point Aₙ₊₁ are retrieved from the process controller, which controls the working process, and, mostly preferred, they are retrieved by the manipulator controller from the process controller.

If, for example, a subsequent working point Aₙ₊₁ is present, the communication between the manipulator controller and the process controller is activated in the background of the working process, either via I/O-signals or XML-strings, or other known communication protocols. The data sets for the subsequent working point Aₙ₊₁ are then retrieved by the manipulator controller from the process controller. For such a communication, it is preferably required that the process controller is adapted for simultaneously controlling the working process and communicating data.

Preferably, the step of checking whether a further working point Aₙ₊₁ is present, is carried out while the manipulator is positioned at working point Aₙ. As already mentioned, this may also entail that the manipulator is in the middle of the corresponding working process, i.e. along the corresponding path of the working process. Therefore checking is performed after the manipulator has reached working point Aₙ. Alternatively, the step of checking may also be performed along the way to the working point Aₙ, or may be started along the way to working point, and may be terminated after reaching working point Aₙ. Due to the preliminary checking of the presence of a subsequent working point Aₙ+1, the progress of the working process is optimized, since in case of absence of a subsequent working point Aₙ+1, no data sets are retrieved.

Preferably, the method also comprises a step of applying the retrieved data sets from the retrieving step by the manipulator controller to a path planning for approaching the subsequent working point Aₙ+1. An optimized execution of the working process is thus advantageously allowed, since the manipulator controller is provided with the information, i.e. data sets defining the path or motion planning of the manipulator at an early stage, i.e. before reaching the subsequent working point Aₙ+1. The approaching of the subsequent working point Aₙ₊₁ may therefore be possibly optimized, if the retrieved data sets require or permit a modification or optimization of path planning.

Moreover, preferably, actual data of working point Aₙ and/or actual data of the manipulator at working point Aₙ are sent by the manipulator controller to the process controller, which controls the working process, in particular while the manipulator is positioned at working point Aₙ. These actual data sent are then applied to the process controller, i.e. processed on the latter. By transmitting actual data of working point Aₙ to the process controller, as a communication between manipulator controller and process controller, the working process is further improved, since the process controller may, for example, perform an adaptation of its process planning. This bidirectional communication allows an operator of the process controller to react to data of the manipulator controller or modifications in the actual working process, without requiring an extensive knowledge about the manipulator controller and its data.

The actual data preferably comprise at least the position, arrangement, status and/or location of the one or more manipulators and/or of the end effector, which are in particular detected or measured by the manipulator controller. This list of actual data is not exhaustive, but only an exemplary list. The actual data may further comprise other data/parameters or information known and used for processing and manipulator controlling.

In case of the point welding process, the electrode cap length of the welding electrode may be comprised in the actual data, which are sent by the manipulator controller to the process controller. The evaluation of the electrode cap length is of particular importance for the working process in the subsequent working point Aₙ+1, and for the related path planning of the manipulator.

Moreover, preferably, prior to the step of approaching working point Aₙ, one or more data sets for the working process are stored in the process controller, preferably for each working point.

Moreover, the process controller is implemented in a host PC, and the manipulator controller is controlled through the host PC. Due to this, as previously described, the operator does not require a deep knowledge of the manipulator controller, since the communication between the process controller and the manipulator controller is essentially automated.

The working process is preferably one of the following: clinching, pass-through joining, joining processes in general, resistance point welding, pass-through riveting or riveting in general. Moreover, the working process may comprise any process, which may be carried out by manipulators, for example, such as different types of welding, application processes (for example before a gluing process), measurements/measure processes, etc.

The present invention further comprises a manipulator system, which comprises at least one manipulator, process controller and a manipulator controller. The system is adapted to perform above said inventive method.

### 4. EXEMPLARY EMBODIMENT

The present invention is explained in the following by means of annexed figures. In particular:

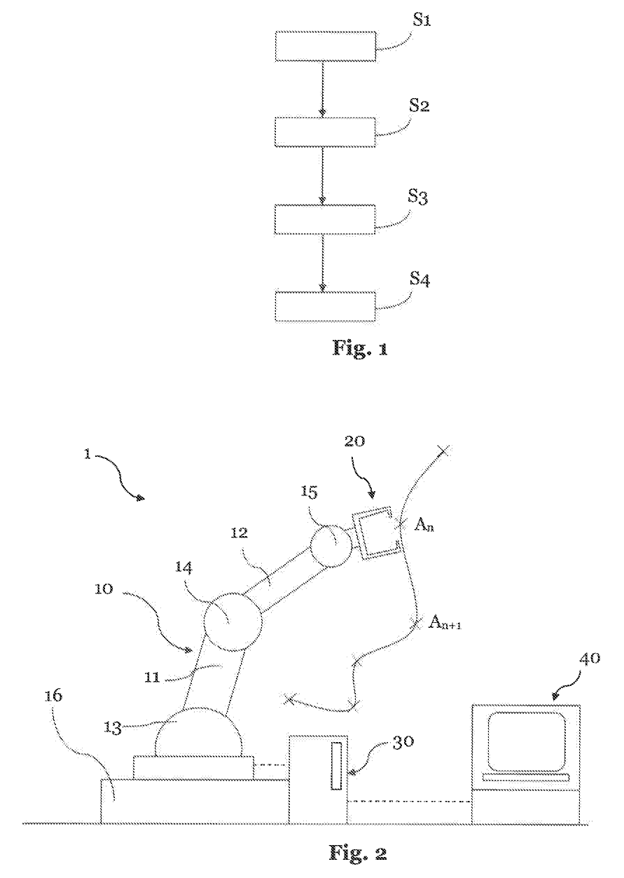

FIG. 1 shows a schematic flow chart for an inventive method, and

FIG. 2 schematically shows a manipulator system for carrying out the method.

As shown in FIG. 1, in a first step S1, various working points are provided, which have to be approached by a manipulator. These points are preferably provided to a process controller, which is provided on a host PC. The process controller is communicating with the manipulator controller, which usually is a proprietary system of the manipulator manufacturer, which is separated from the process controller. The working points are certain spatial coordinates, for example, at which the manipulator has to carry out certain working processes, such as the application of a welding point. At step S2, the manipulator approaches a working point Aₙ. To this end, the manipulator controller has received from the process controller the spatial coordinates of the working points, for example, and has calculated a certain path planning, which is autonomously followed by the manipulator. At step S3, the manipulator controller checks, whether, after working point Aₙ, a subsequent working point Aₙ₊₁ is present. If not, the working process is terminated. The checking may be performed, for example, while the manipulator approaches working point Aₙ, i.e. on its way towards this working point Aₙ. However, checking may also be performed when the manipulator has ended its approaching, i.e. when it has reached working point Aₙ.

If, by this checking, it is determined that a subsequent working point Aₙ₊₁ is present, then, at step S4, the manipulator controller retrieves data sets for the subsequent working process from process controller, in particular prior to manipulator leaving working point Aₙ. The retrieval of data sets for the subsequent working process Aₙ₊₁ thus occurs while working process at working point Aₙ is still being carried out.

FIG. 2 schematically shows a manipulator system 1, which comprises a manipulator 10, a manipulator controller 30 and a process controller 40. The manipulator 10 preferably a multi-axis articulated arm robot, which comprises a plurality of members 11, 12, which are connected to each other by means of rotary joints 13, 14 and 15. The manipulates 10 is attached to a pedestal 16. The manipulates 10 is provided at as hand flange with an effector 20, which, in the example shown, is a welding clamp for point welding. The manipulates controller 30 is housed inside its own housing and runs on its micro-PC or similar, for example. The process controller 40 also runs on own PC and sends commands to the manipulator controller 30, in order to control the working process of the manipulator 10 known the manipulator controller 30 implements commands of the process controller 40. When the process controller 40 instructs, for example, that the manipulator 10 (or the effector 20) has to approach a certain spatial coordinate, then the manipulate controller 30 calculates the path planning, i.e. the motion path traveled by manipulator, in order to reach the predetermined spatial coordinate.

In FIG. 2 a series of crosses is shown, which indicate different working points, which the manipulator 10 or the effector 20 has to approach. The curve should indicate the planned path, which the manipulator controller 30 has calculated, in order for the manipulator 10 to approach all predetermined working points, possibly without conspicuous deviations. The working points themselves are predetermined or set by the process controller. At each working point, the effector 20 has to be oriented in a certain orientation and afterwards it has to apply a welding point by using a predetermined welding power (current ramp angle, welding duration, optional cooling phases, etc.). These process data are also provided to the manipulator controller 30 by the process controller 40. Depending on the working process, it may occur, that certain parameters vary, such as the electrode cap length, which is regularly detected by the manipulator controller 30, in that both electrode caps are brought together and the current rise is measured. The length variation may be calculated from these data.

In the example shown, the manipulator 10 or effector 20 is at a working point Aₙ, i.e. the manipulator has completely reached the working point Aₙ. In the position shown, a first welding point has to be applied. While the manipulator 10 performs the corresponding welding process, the manipulator controller 30 checks, whether a subsequent working point Aₙ₊₁ is provided. If this is true, the manipulator controller 30 asks the process controller 40 to provide the required data sets (current ramp angle, welding time, optional cooling phases, etc.) for the subsequent working point Aₙ+1. These data sets are then preferably considered by the manipulator controller 30 in the new calculation of the planned path for approaching the subsequent working point Aₙ+1. The manipulator controller 30 also preferably transmits, while the manipulator 10 is working at working point Aₙ, actual data regarding working point Aₙ to the process controller 40. These actual data may refer, for example, to the actual welding force, the metal sheet thickness tolerance (the welding clamp determines, for example, at each point, the thickness of the sheet metal and calculates a tolerance based thereon) and other important parameters. These actual data may be used by the process controller 40, in order to adapt or optimize the subsequent working processes, for example.

### REFERENCE LIST

S1 to S4 method steps
1 manipulator system
10 manipulator
11,12 members
13, 14, 15 joints
16 pedestal
20 effector
30 manipulator controller
40 process controller

1. A method for controlling at least one manipulator for carrying out a working process, which is controlled by a process controller, wherein the method comprises following steps:
a) providing one or more working points, which have to be approached by the manipulator;
b) approaching a working point Aₙ by the manipulator;
c) checking, whether a subsequent working point Aₙ₊₁ is present; and
d) if a subsequent working point Aₙ₊₁ is present, retrieving one or more data sets for the subsequent working point Aₙ₊₁, while the working process is being earned out at the working point Aₙ.

2. The method of claim 1, wherein the one or more data sets are retrieved at step d) by the manipulator controller.

3. The method of claim 1, wherein the one or more data sets are retrieved at step d) from the process controller, which controls the working process.

4. The method of claim 1, wherein the checking at step c) is carried out, while the manipulator is at working point Aₙ.

5. The method of claim 1, further comprising the following step:
applying, by the manipulator controller, of the retrieved data sets from step d) on a path planning for approaching the subsequent working point Aₙ₊₁.

6. The method of claim 1, further comprising the steps of:
sending actual data of working point Aₙ and/or actual data of the manipulator at working point Aₙ by the manipulator controller to the process controller, which controls the working process, while the manipulator is at working point Aₙ, and
applying the actual data sent to the process controller.

7. The method of claim 6, wherein the actual data at least comprise: position, arrangement, status, location of the one or more manipulators, and end effector position.

8. The method of claim 1, further comprising the following step before step b):
storing, for each working point, one or more data sets for the working process in the process controller, which controls the working process.

9. The method of claim 1, further comprising the steps of:
implementing the process controller in a host PC; and
controlling the manipulator controller through the host PC.

10. The method of claim 1, wherein the working process is selected from the group consisting of joining processes and riveting processes.

11. A manipulator system, comprising:
at least one manipulator;
a process controller; and
a manipulator controller,
wherein the system is configured to:
a) provide one or more working points, which have to be approached by the at least one manipulator;
b) approach a working point Aₙ by the manipulator;
c) check whether a subsequent working point Aₙ₊₁ is present; and
d) if a subsequent working point Aₙ₊₁ is present, retrieve one or more data sets for the subsequent working point Aₙ₊₁, while the working process is being carried out at the working point Aₙ.

12. The method of claim 10, wherein the working process is selected from the group consisting of clinching and pass-through joining.

13. The method of claim 10, wherein the working process is selected from the group consisting of resistance point welding and pass-through riveting.
